(19) United States
(12) Patent Application Publication
(10) Pub. No.: US 2010/0252751 A1
(43) Pub. Date: Oct. 7, 2010

(54) MICROELECTRONIC OPIACAL EVANESCENT FIELD SENSOR

(75) Inventors: Derk Jan Wilfred Klunder, Eindhoven (NL); Christianne Rossetta Maria De Witz, Eindhoven (NL); Roel Penterman, Eindhoven (NL); Ruth Wilhelmine Ireen De Boer, Eindhoven (NL); Erik Martinus Hubertus Petrus Van Dijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/740,149

(22) PCT Filed: Oct. 30, 2008
(86) PCT No.: PCT/IB2008/054522

§ 371 Date: Apr. 28, 2010

(30) Foreign Application Priority Data
Nov. 5, 2007 (EP) 07119945.9
Jul. 25, 2008 (EP) 08161180.8

(51) Int. Cl. G01J 1/58; G01N 21/64

(52) U.S. Cl. 250/459.1; 250/458.1; 250/216

(57) ABSTRACT

There is provided a microelectronic sensor device (100) for the detection of target components (10) near a binding surface (12), comprising a source (21) for emitting a beam (101) of radiation having a wavelength incident at the binding surface (12); an optical structure (11) near the binding surface (12), for providing evanescent radiation, in response to the radiation incident at the binding surface (12), in a detection volume (4) bound by the binding surface (12) and extending over a decaylength away from the binding surface (12) into a sample chamber (2); and a detector (31) for detecting radiation (102) from the target component (10)1 present in the detection volume (4), in response to the emitted incident radiation (101) from the source (21) wherein the binding surface (12) is provided with upstanding walls of a dielectric material (3), for providing one or more detection volumes (4) bound to a maximum in plane detection volume dimension (W1) smaller than a diffraction limit, the diffraction limit defined by the radiation wavelength and the medium (2) for containing the target components (10).

### FIELD OF THE INVENTION

The invention relates to an optical device and a microelectronic sensor device comprising the optical device, for the detection of target components.

### BACKGROUND OF THE INVENTION

In an inhomogeneous assay, the concentration of a targeted bio-molecule can be determined by measuring the surface concentration of the targeted bio-molecule or beads that are representative for the targeted bio molecule] bound at the sensor surface. As an example, one can think of a competitive assay where the binding surface (substrate) is covered with target molecules. The beads may be covered with specific [for the target molecule] antibodies and are dispersed in a fluid that contains the target molecules. The free target molecule in the sample competes with the immobilized target molecule on the sensor surface for binding to the antibody-coated bead. In case of a low concentration, the chance that an antibody binds with a target molecule at the sensor surface is higher than the chance that an antibody binds with a target molecule in the solution. By measuring the surface concentration of beads that are bound at the substrate, one can determine the concentration of the target molecule. Accurate measurement of the concentration however requires a highly surface specific detection scheme that is sufficiently insensitive for beads in the solution. Furthermore, the detected signal should be independent from the sample matrix, which can be whole-blood, whole-saliva, urine or any other biological fluid.

For optical detection schemes high surface specificity can be achieved by reducing the measurement volume. One-way to achieve this is by confocal imaging where the measurement volume is reduced to typically a few wavelengths (e.g., 1 micron). However, DNA-sequencing is an example where a measurement volume is preferably further reduced, up to a volume that is equivalent a volume containing a single molecule. In this volume, real time sequencing could be monitored and identified by identifying labeled nucleotides that are involved in a subsequent DNA-polymerase reaction of the single molecule. In this context, US 2006/0098927 discloses a method for the investigation of DNA molecules wherein so-called nano-pores are provided in a fluid passage of a fluid core of an optical waveguide, to limit passage of a single molecule at a time.

U.S. Pat. No. 7,013,054 is a prior art publication that uses a pinhole matrix to generate an evanescent field instead of micro fluidic channels; however, this publication sets a relationship between the measurement volume of the pinhole and the evanescent field. This limits the detection possibilities since the measurement volume is dependent on an aperture width.

### SUMMARY OF THE INVENTION

A desire exists to provide a microelectronic sensor device for the detection of target components wherein the volume for containing the target components does not limit the decay length of the generated evanescent field, for example, to provide the sensor device for DNA-sequencing purposes. Accordingly, in one aspect of the invention, there is provided an optical device, for providing evanescent radiation, in response to incident radiation, in a detection volume for containing a target component in a medium, the detection volume having at least one in-plane dimension (W1) smaller than a diffraction limit, the diffraction limit defined by the radiation wavelength and the medium for containing the target components; wherein the detection volume is provided with at least one wall of a dielectric material.

Preferably, this dielectric material is selected from the group comprising poly(tetrafluoroethene), SiO₂, Si₃N₄, SiOₓN_{y} wherein x and y represent the relative fractions, or combinations thereof.

In another aspect of the invention there is provided a method of detecting target components in a medium in one or more detection volumes of an optical device, the detection volume having at least one in-plane dimension (W1) smaller than a diffraction limit, the diffraction limit defined by the radiation wavelength and the medium for containing the target components comprising: emitting a beam of radiation having a wavelength incident at the optical device; providing, by the optical device, evanescent radiation, in response to the radiation incident at the optical device, in the detection volume; detecting radiation from the target component present in the detection volume, in response to the emitted incident radiation; and bounding said one or more detection volumes by at least one upstanding wall of a dielectric material.

In still another aspect of the invention there is provided a method of manufacturing a carrier comprising: providing, on a substrate, aperture defining structures, having a smallest in plane aperture dimension (W1′) smaller than the diffraction limit; and a largest in plane aperture dimension W2 larger than the diffraction limit and having out of plane dimension D; filling said aperture defining structures by a dielectric material, to provide a top layer on the aperture defining structures that extends from said structures in an out of plane direction over a distance substantially equal to the out of plane dimension D; providing slit patterns in the dielectric oriented transverse to the largest in plane aperture dimension; and etching the top layer back to the out of plane dimension D, so as to provide, in the aperture defining structures upstanding walls of a dielectric material, for providing one or more detection volumes having an in plane detection volume dimension (W1) smaller than a diffraction limit, the diffraction limit defined by the radiation wavelength and the medium for containing the target components.

These and other aspects of the invention will be apparent from and elucidated with reference to the embodiment(s) described hereinafter.

### BRIEF DESCRIPTION OF THE DRAWINGS

FIG. 1a shows a first schematic embodiment according to an aspect of the invention;

FIG. 1b shows an alternative embodiment according to the invention;

FIG. 2 shows a schematic top and side view of the carrier in the embodiment of FIG. 1;

FIG. 3 schematically shows a manufacturing process for providing the first embodiment;

FIG. 4 shows a second embodiment according to an aspect of the invention;

FIG. 5 shows a graph detailing a decay length for the embodiment of FIG. 4;

FIG. 6 shows an alternative embodiment for the embodiment of FIG. 4; and

FIG. 7 shows an alternative embodiment for the embodiment of FIG. 4.

### DETAILED DESCRIPTION OF EMBODIMENTS

The microelectronic sensor device according to the present invention may serve for the qualitative or quantitative detection of target components, wherein the target components may for example be biological substances like biomolecules, complexes, cell fractions or cells. The term “target components” shall denote any particle (atom, molecule, complex, nanoparticle, microparticle etc.) that has some property (e.g. optical density, magnetic susceptibility, electrical charge or luminescence), including a possible label particle which can be detected, thus (indirectly) revealing the presence of the associated target component. A “target component” and a “label particle” may be identical. In addition, the microelectronic sensor device, according to an aspect, may comprise the following components:

a) A carrier with a binding surface at which target components can collect, although in principle, the optical device may define a detection volume without a binding surface. The term “binding surface” is chosen here primarily as a unique reference to a particular part of the surface of the carrier, and though the target components will in many applications actually bind to said surface, this does not necessarily need to be the case. The target components reach the binding surface to collect there (typically in concentrations determined by parameters associated to the target components, to their interaction with the binding surface, to their mobility and the like). In a transmissive arrangement, the carrier preferably has a high transparency for light of a given spectral range, particularly light emitted by the light source that will be defined below. The carrier may for example be produced from glass or some transparent plastic. The carrier may be permeable; it provides a carrying function for aperture defining structures provided on the carrier having a smallest in plane aperture dimension (W1) smaller than a diffraction limit
b) A source for emitting a beam of radiation, called “incident light beam” in the following, into the aforementioned carrier such that it is reflected, at least in an investigation region at the binding surface of the carrier. The light source may for example be a laser or a light emitting diode (LED), optionally provided with some optics for shaping and directing the incident light beam. The “investigation region” may be a sub-region of the binding surface or comprise the complete binding surface; it will typically have the shape of a substantially circular spot that is illuminated by the incident light beam.
c) A detector for detecting radiation from the target component present in the detection volume, in response to the emitted incident radiation from the source. It is noted that the term “radiation from the target component” includes any radiation that is detectable for detecting a presence of the target component, possibly including any label particles. Without limitation, the radiation may be of a scattered, reflected or luminescent type. The detector may comprise any suitable sensor or plurality of sensors by which light of a given spectrum can be detected, for example a photodiode, a photo resistor, a photocell, or a photo multiplier tube. Where in this specification the term light or radiation is used, it is meant to encompass all types of electromagnetic radiation, in particular, depending on context, as well visible as non visible electromagnetic radiation.
d) Near the binding surface an optical structure is provided, for providing evanescent radiation, in response to the radiation incident at the binding surface, in a detection volume bound by the binding surface and extending over a decay length away from the binding surface into a sample chamber. It is noted that the term “evanescent radiation” in a given medium refers to non-propagating waves having a spatial frequency that is larger than the wave-number of a given medium (that is the wave-number in vacuum times the refractive index of the medium). Examples are evanescent waves generated by total internal reflection or by incidence on a sub-diffraction limited apertures. In particular, the evanescent wave-field will decay with a 1/e decay length of typically 10-500 nm depending on the illumination light. In addition, it is noted that the optical structure is preferably be of a kind that the evanescent field substantially does not propagate after the optical structure, which means that an out of plane dimension of the aperture defining structure is substantially larger than the 1/e decay length.

The microelectronic sensor device allows a sensitive and precise quantitative or qualitative detection of target components in an investigation region at the binding surface. One advantage of the described optical detection procedure comprises its accuracy as the evanescent waves explore only a small volume that extends typically 10 to 30 nm into the aperture from the end of the aperture adjacent to the carrier, thus avoiding disturbances (such as scattering, reflection, luminescence) from the bulk material behind this volume.

The microelectronic sensor device may be used for a qualitative detection of target components, yielding for example a simple binary response with respect to a particular target molecule (“present” or “not-present”). The sensor device may comprise however an evaluation module for quantitatively determining the amount of target components in the investigation region from the detected reflected light. This can for example be based on the fact that the amount of light in an evanescent light wave, that is absorbed or scattered by target components, is proportional to the concentration of these target components in the investigation region. The amount of target components in the investigation region may in turn be indicative of the concentration of these components in a sample fluid that is in communication with the aperture according to the kinetics of the related binding processes.

In a preferred embodiment, the binding surface of the sensor is provided with a plurality of aperture defining structures having a first smallest in plane aperture dimension (W1) smaller than a diffraction limit, the diffraction limit (Wmin) defined by a medium for containing the target components: by:

Wmin=λ/(2*n_{medium}) (1)

with λ the wavelength in vacuum and n_{medium} the refractive index of the medium in front of the wire grid. Typically, the wavelengths will vary in a (near) visible range of 400-800 nm; typically corresponding to a minimum aperture of 150-300 nm in water. In a preferred embodiment, the aperture defining structure defines a first and a second in-plane vector that are parallel to a slab of material that is not transparent (examples are metals such as gold (Au), silver (Ag), chromium (Cr), aluminium (Al)). The first (smallest) in-plane aperture dimension is parallel to the first in-plane vector and the second (largest) in-plane aperture dimension is parallel to the second in-plane vector.

Accordingly following types of apertures can be distinguished:

1. Apertures of the first-type with a first in-plane dimension W1 below the diffraction limit and a second in-plane dimension W2 above the diffraction limit there is a transmission plane that is composed of the first in-plane vector and a third vector that is normal to the first and second in-plane vectors. R-polarized incident light, that is light having an electric field orthogonal to the plane of transmission, is substantially reflected by the aperture defining structure and generates an evanescent field inside the aperture. T-polarized light incident on an aperture defining structure composed of apertures of the first type, that is light having an electric field parallel to the planes of transmission of the one or more apertures, is substantially transmitted by the aperture defining structure and generates a propagating field inside the aperture.
2. For apertures of the second-type with both in-plane dimensions below the diffraction limit we cannot define a plane of transmission. Incident light of any polarization (such as linearly, circularly, elliptically, randomly polarized) is substantially reflected by the aperture defining structure and generates an evanescent field inside the aperture.

As an example, for a wire grid with one in-plane dimension just above and the other just below the diffraction limit and assuming an evanescent decay length of 30 nm, we find an excitation volume of (assuming red excitation light 632.8 nm and water in between the wires) of 30×244×244 nm3. This corresponds with a concentration of 0.9 mmolar for one molecule inside the excitation volume.

It is noted that the generation of an evanescent field is also possible using total internal reflection. Depending on the index of refraction nglass for the glass prism, the angle of incidence θ_{A} in the carrier, and the wavelength λ of the used light, the magnitude of evanescent field can be described as:

exp(−k\sqrt{n_{glass}² sin²(θ_{A})−n_{fluid}²}·z)

with z the distance from the interface and k the wavenumber (2π/λ). The penetration depth into water ((1/e) intensity) ranges from 100 nm for silica (index of refraction 1.45) down to 35 nm for a high index glass (index of refraction 2) at a beam angle of 80 degrees with respect to the normal of the detection surface. Here it is assumed that the sample matrix has refractive index nfluid=1.33 (similar to water) and that the wavelength of the used light is 650 nm (DVD laser).

For most practical applications the penetration of the evanescent field into a sample matrix on top of the carrier is limited to particles bound to the substrate. The penetration depth t_{decay} (1/e intensity of the evanescent field) depends on the refractive index of the prism (nglass) and the sample matrix (nfluid) and the angle of incidence (α):

t_{decay}=λ/4·π·√[(n_{glass}·sin(α))²−n_{fluid}²]) (2)

As an example, for a decay length of for instance 30 nm would correspond to an index of the prism of at least 1.87. For prisms made of low-cost material such as Polystyrene and Polycarbonate, with typical refractive indexes of 1.55 and 1.58 respectively, the penetration depth in water is limited to a minimum of 65 nm and 60 nm respectively.

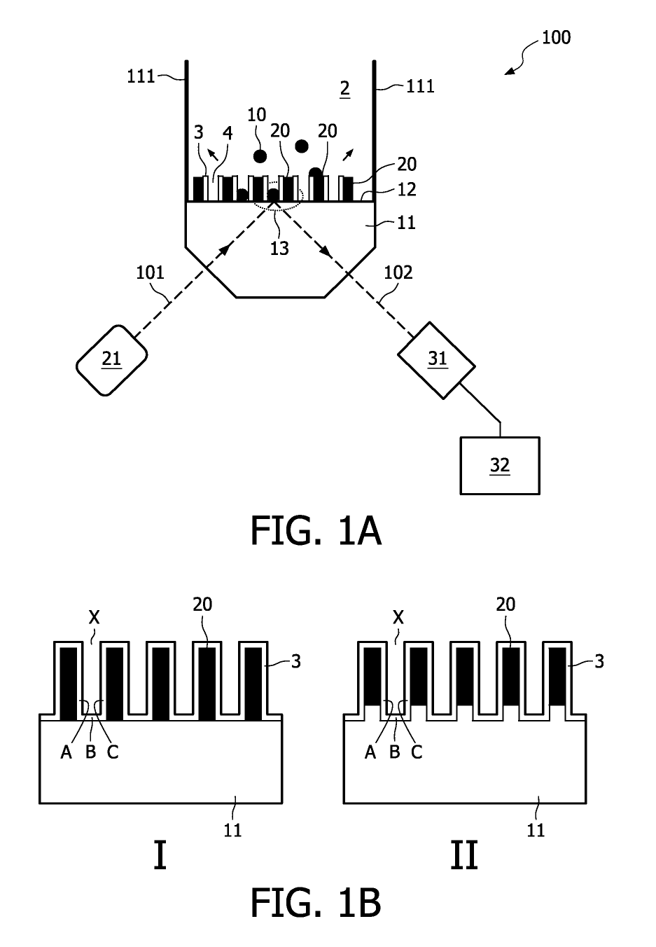

Turning to FIG. 1a, a general setup is shown of a microelectronic sensor device 100 according to an aspect of the present invention. Carrier 11 may for example be made from glass or transparent plastic like polystyrene. The carrier 11 is located next to a sample chamber 2—and actually forms one of the walls of the sample chamber 2—in which a sample fluid with target components to be detected (e.g. drugs, antibodies, DNA, etc.) can be provided. Chamber 2 may in addition be defined by upstanding walls 111 that, in a preferred embodiment, are repeated continuously to form a plurality of adjacent walls 111, forming a well-plate for example, for microbiological assays. The sample further comprises particles 10, for example particles 10 that are usually functionalized with binding sites (e.g., antibodies) for specific binding of aforementioned target components. The particles may be electrically charged or fluorescent particles or have some other detectable characteristic.

The interface between the carrier 11 and the sample chamber 2 is formed by a surface called “binding surface” 12. This binding surface 12 may optionally be coated with capture elements, e.g. antibodies, ligands, which can specifically bind the target components.

The sensor device further comprises a light source 21, for example a laser or a LED, that generates an incident light beam 101 which is transmitted into the carrier 11. The incident light beam 101 arrives at the binding surface 12 and is in this example reflected as a “reflected light beam” 102. The reflected light beam 102 leaves the carrier 11 and is detected by a light detector 31, e.g. a photodiode. The light detector 31 determines the power/energy of the reflected light beam 102 (e.g. expressed by the light intensity of this light beam in the whole spectrum or a certain part of the spectrum). The measurement results are evaluated and optionally monitored over an observation period by an evaluation and recording module 32 that is coupled to the detector 31. On the carrier surface 12, a slab of material that is not transparent, preferably metal (for example gold (Au), silver (Ag), chromium (Cr), aluminium (Al)) is provided in the form of strips 20, defining a wire grid having a smallest in plane aperture dimension (W1) smaller than a diffraction limit, the diffraction limit defined by the ratio between wavelength and twice the refractive index of the medium 2 containing the target components 10. The angle of incidence θ can in principle vary from 0 to 90°. Due to the diffraction limited nature of the aperture, in investigation area 13 an evanescent field is created that may be selectively disturbed due to the presence of particles that are bound by carrier surface 12 or at least within reach of the evanescent field generated by the aperture defining structures 20.

In addition to the strips 20, upstanding walls 3 are provided of a dielectric material for instance a material, having a refractive index between 1.2 and 3.4. Poly(tetrafluoroethene), SiO₂, Si₃N₄, SiOₓN_{y} wherein x and y represent the relative fractions, or combinations thereof are suitable non limiting examples of usable dielectric materials.

Accordingly, measurements volumes 4 are formed wherein the particles 10 can be detected by an optical response to incidence light beam 101. The optical response is detected as reflective light beam 102. Accordingly, the detection volume is limited to a maximum in-plane detection volume dimension W1 smaller than a diffraction limit. By covering the metal strips 20 with dielectric material 3—fluorescence-quenching effects due to the presence of metal material can be considerably reduced. Preferably, to optimize this effect, not only the metal, but the total detection volume is provided with a layer of dielectric material. By way of example, such an arrangement is illustrated in FIG. 1b, where all the walls A-C of the aperture X are coated with dielectric material 3. This has as an additional advantage that preferential wetting of the fluid on top of the wire grid on part of the space between the wires, is prevented. In general a lower surface tension implies better wetting of a fluid and wetting properties of metals (e.g., surface tension of 871.03 dyne/cm for aluminium and 579.56 dyne/cm for aluminium oxide) and dielectric materials (e.g., surface tension of 205.70 dyne/cm for SiO2) are quite different.

Dielectric materials that can be used according to the present invention preferably have a refractive index close to that of water (1.33) as the detection volume is typically filled with a fluid such as water. Refractive indexes of 1 to 1.7, more preferably 1.2 to 1.5, are envisioned. Examples of dielectric materials for use according to the invention comprise but are not limited to poly(tetrafluoroethene) (1.29-1.31), SiO₂ (1.46) and SiOₓN_{y}. SiOₓN_{y} has a refractive index between 1.48 (x=1, y=0; with x the Oxide fraction) to 2.0 (x=0;y=1).

The described microelectronic sensor device 100 applies optical means 31 for the detection of particles 10 and the target components one is actually interested in. For eliminating or at least minimizing the influence of background (e.g. of the sample fluid, such as saliva, blood, etc.), the detection technique is preferably surface-specific.

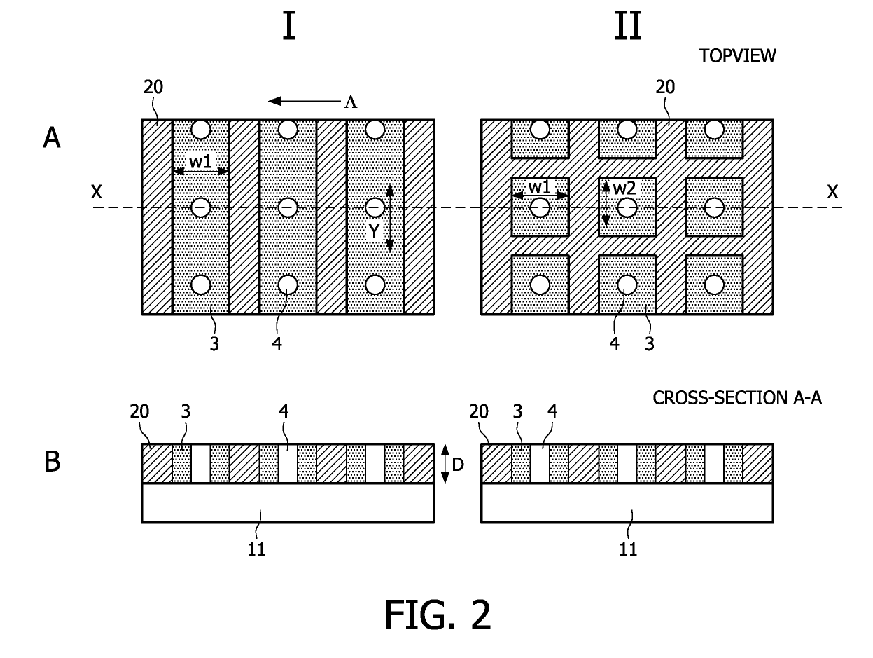

Although the invention can be applied in a periodic structure (grating structure of a period λ), this is not necessary, indeed the structure may also be a-periodic or quasi periodic. The aperture dimension W1 of the smallest dimension, or, if applicable, a grating period Λ, is typically smaller than the diffraction limit, the diffraction limit defined by a principal wavelength or band of wavelengths of the incident light beam and a medium for containing the target components. Preferably, the incident light beam 101 is exclusively comprised of radiation having wavelengths above the diffraction limit. A nice property of aperture defining structures 20 with apertures of the first-type as defined here above and as depicted on FIG. 2-I, such as the wire-grid technology is that the light inside the aperture can be switched from an evanescent mode to a propagating mode quite easily by switching the polarization of the input light, which enables both surface specific and bulk measurements.

Turning to FIG. 2 a top view (A) and a side view (B) are shown along section

X-X of the carrier 11 having strips 20 provided thereon to provide evanescent radiation. The strips 20 are dimensioned according to first (I) and second (II) aperture types described here above. In particular FIG. 2-I shows an embodiment having an aperture with a first in-plane dimension W1 below the diffraction limit for incident radiation, (see FIG. 1a) and a second in-plane dimension W2 having a dimension above the diffraction limit; in the figure, W2 extends along direction Y. Preferably, at least one of the in plane detection volume dimensions is smaller than 250 nm, even more preferably smaller than 50 nm.

In contrast embodiment 2-II shows a pinhole variant having in-plane dimensions W1 and W2 that are below the diffraction limit. More specifically, in this embodiment, nano-hole 4 has a diameter of about 50 nm or smaller, ensuring that there is on average only a single nucleotide in the excitation volume for a micro-molar concentration. Evanescent decay lengths in between the wires of the wire grid are typically 30 nm. Preferably, the dielectric material 3 has roughly the same index as the material 2 (e.g., water, See FIG. 1) that fills the nano-holes 4 in order to avoid scattering. TEFLON may be a good candidate has an index of refraction similar to water. Preferably the dielectric material 3 has properties that prevent the nucleotides or other molecules that are present in the buffer solution, sticking onto the surface. Covering the metal wires 20 with this material 3 may further reduce the interaction between the substrate and the solution.

The wiregrids 20 may have a period (A) and define, as shown in FIG. 2-II, an aperture W1 and thickness D. The diffraction limit may typically be defined as a wavelength in the medium of twice the smallest aperture dimension.

As an alternative the wiregrids 20 of the first type of FIG. 2-I may be replaced by an array of 2D sub-diffraction limited apertures of the second type, also referenced as a pin-hole structure (see FIG. 2-II). In this case the aperture defining structures is composed of apertures of the second-type mentioned here above. Accordingly these arrays have a high reflection (and evanescent fields inside the apertures) for any polarization.

In FIG. 2 accordingly a detection volume 4 is provided that can be shaped to a single molecule detection volume, for example of biomolecules, in particular DNA-molecules to be sequenced. For these applications it may be of importance that a single molecule is provided in the detection volume to properly identify subsequent hybridization of specific label components. In particular, the measurement volume can be a volume defined by dimensions to 50 nanometers squared in-plane of the detection surface 12, and a height D of the optical structure in the forms of strips 20 that may be around 150 nanometers, resulting in a measurement volume that extends 20-40 nm into the medium for containing the target components, for a wavelength in vacuum of 650 nm

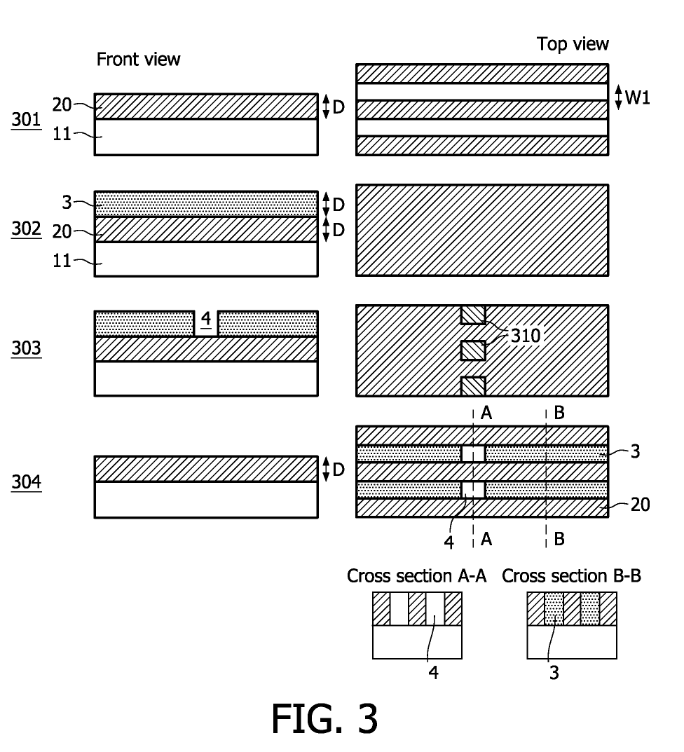

Turning to FIG. 3 subsequent steps are illustrated in the front view and the top view of the optical structure 20, to be provided with detection volumes 4. As can be shown in the first step 301 a substrate 11 is provided with the slit structures or aperture defining structures 20 as referred to in FIG. 2, in particular having an out-of-plane thickness D and a first in-plan dimension W1 of the aperture. As can be shown in step 302 of FIG. 3a dielectric material 3, for instance TEFLON, is provided on the slit structures 20, having an out-of-plane thickness of substantially the same dimension as the out-of-plane thickness of the slit structures 20. In a subsequent step 303 a pattern 310 is provided by stamping strips in a direction transverse to the slits 20, this is schematically illustrated by hole 4 in step 303. In step 304 the dielectric layer 3 is etched back to an out-of-plane thickness D so that upstanding walls 3 are provided and a detection volume 4 at least partly surrounded by a dielectric material 3. To reduce scattering or reflection effects, preferably the dielectric material 3 matches a medium index of diffraction of a medium 2 that is provided on top of the carrier 11 (see FIG. 1). A material of choice could be poly(tetrafluoroethene), SiO₂, Si₃N₄, SiOₓN_{y} wherein x and y represent the relative fractions, or combinations thereof.

The in-plane dimension of detection volume 4 is determined by the dimension of the nano-hole that is defined in the dielectric material. The out-of-plane dimension of detection volume 4 is determined by the evanescent decay length of the excitation intensity, for example an evanescent decay length of the excitation intensity is about 30 nm. For wire grids having 100 nm thick wires (out of plane dimension) and a spacing between adjacent wires of 50 nm, an evanescent decay length of 14 nm is obtained for TE polarized excitation light of a wavelength of 632.8 nm and an excitation volume of 14*50*50=35000 nm3. This volume can be sufficiently small for having on average a single nucleotide inside the excitation volume for a concentration of up to 47 micro molar; for a concentration of 10 micro molar the width of the strips of the stamp can be increased to 230 nm.

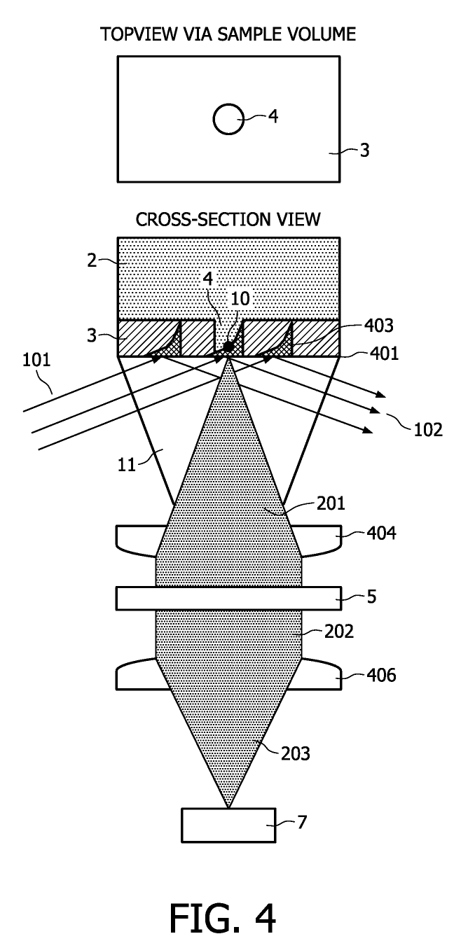

FIG. 4 illustrates an embodiment using total internal reflection by incident beam 101 and reflective beam 102, here a top transparent layer 3 is provided of a dielectric medium, patterned with holes 4 to provide detection volumes. The dielectric layer 3 and carrier layer 11 define a layer interface 401 wherein a lower transparent layer 11 has a refractive index larger than the top dielectric layer 3. In this arrangement, by total internal reflection, evanescent radiation 403 is generated that decays over a decay length that is preferably of the same dimension or smaller as the dielectric thickness layer 3. In one aspect the targets components are optically different from the medium index and accordingly have an (complex) index of refraction different from the medium index of refraction.

Accordingly prism 11 has a reflective index NPA higher than index of the sample medium 2, dielectric material 3 (index nd) is patterned with nano-holes 4 having sub-diffraction limited in-plane dimensions. A lens system 404, 406 is provided to detect an optical response from particle 10, for example fluorescence or another optical response (scattering). In the situation that fluorescence light 201 is detected scattered radiation light 101 can be blocked by filter 5 and fluorescent light 202 can be transmitted. A detector 7 detects fluorescent light 202 that is focused as an incident beam 203 on the detector 7.

For an intensity decay length of for instance 30 nm in water and a wavelength of 650 nm, the index of the prism could be 1.87 or higher. With low-cost material such as Polystyrene and Polycarbonate, typical refractive indexes are 1.55 and 1.58 respectively, limiting a penetration depth in water to 65 nm and 60 nm respectively. Accordingly, this embodiment discloses total internal reflection (by using a prism 11). According to an aspect, a surface dielectric material 3 is patterned with nano-holes and has an index of refraction that is in between the refractive indexes of the substrate (11) and the sample (2) or is equal to the refractive index of the sample medium 2.

Instead of having the dielectric material (2) directly on a prism, one can also deposit the layer 2 on a flat substrate and place this substrate on top of the prism. Preferably, one uses an index-matching fluid between the substrate and prism to enable in-coupling of the light into the substrate without the requirement of contact between the substrate and the prisms prevent reflections at the prism-substrate interface.

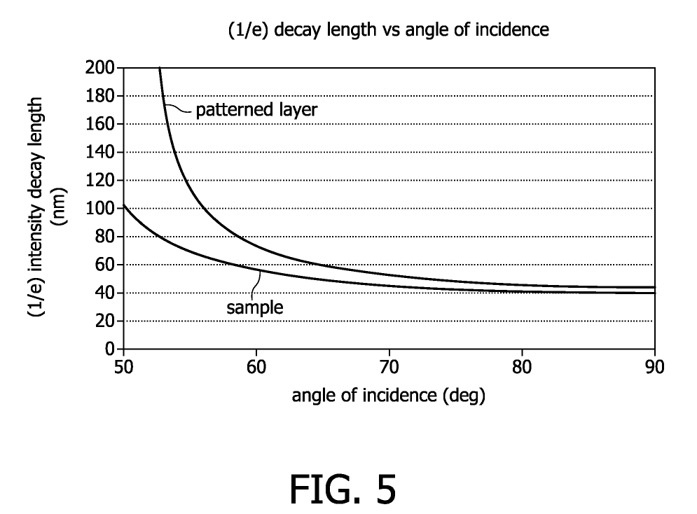

FIG. 5 shows for a typical example involving a prism made of LaSF9 (index of 1.85), an excitation wavelength of 632.8 nm, a water sample (index 1.33) and SiO2 (index 1.45) as patterned dielectric material on top of the prism that a minimum value of the evanescent decay length (1/e intensity) depending on the angle of incidence is 40-50 nm. Assuming a nucleotide/label concentration of 10 micro molar, a volume equivalent to a single nucleotide/label would be 1.66×105 nm3. As a result, the diameter of a cylindrical nano-hole may be smaller than 70 nm.

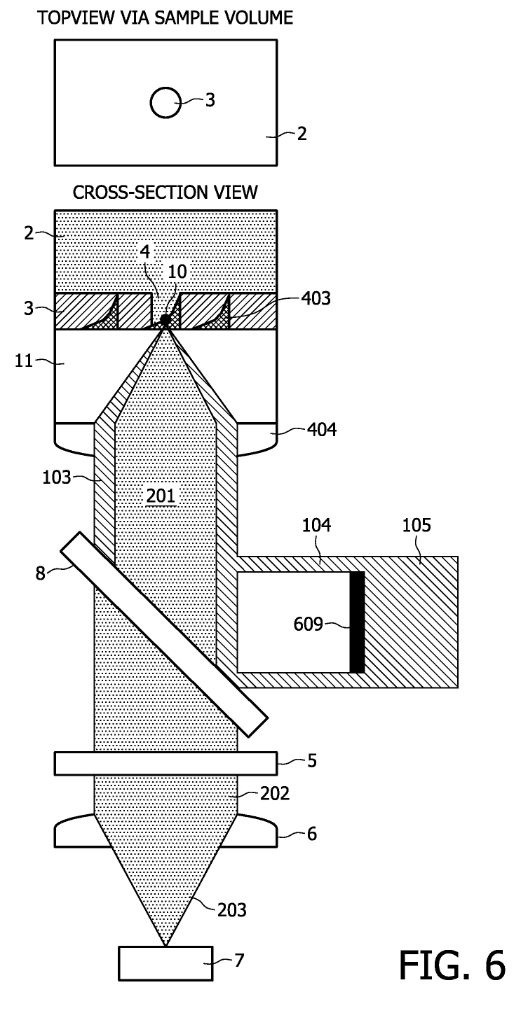

FIG. 6 shows an alternative embodiment wherein evanescent radiation 403 is generated by total internal reflection. Here an objective is illuminated with an annular excitation spot in combination with a patterned layer 3 having sub-diffraction limited nano-holes 4.

Instead of using a prism as in FIG. 4, for the generation of an evanescent field, one can also generate an evanescent field using an objective/lens (404) with index matching fluid (in order to avoid parasitic total internal reflections) between the objective and the slab (11) of high index material. In this case, it is preferable that both that both the objective/lens (404) and the slab (11) have the same refractive index (np) that is higher than the index of the sample medium (2). In order to generate evanescent spots (20), the parallel input beam (105) is converted into an annular spot (104) by using an optical element (609) The optical element (609) can be a mask that blocks the central part of the spot but more preferably is a diffractive element that converts the ‘uniform’ spot into an annular spot. A dichroic mirror (8) may be used for partially overlaying the optical path of the annular spot with the optical path of the fluorescent light (202) and for removal of the reflected excitation light.

In order to illuminate a larger part of the substrate, one can remove optical element (609) and focus the excitation light (105) on the back focal plane of the objective. Blocking filter 5, focusing lens 6 and detector 7 may be designed similar to the embodiment depicted in FIG. 4 to forms fluorescent light on detector 7.

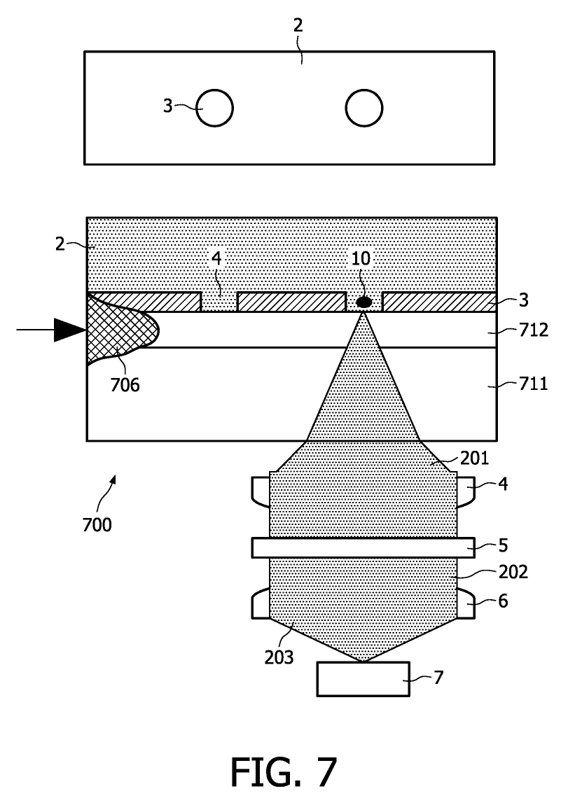

FIG. 7 shows an embodiment wherein an evanescent field 706 is generated by an optical waveguide 712 with a patterned cladding layer 2 on top of the waveguide having sub-diffraction limited nano-holes 4.

In particular dielectric 2 is patterned with nano-holes 4, index of refraction (n3). Preferably the index of refraction is matched with the sample: medium 2.

The waveguide 700 comprises a transparent substrate 711 with an index of refraction (n1) and a transparent core layer 712 with an index of refraction (n2>n1,n3,n4). A good choice for the core material could be Si3N4 which has a high index and is found to be a low loss material. In the dielectric layer 2, waveguide 700 has evanescent tails 706 outside the core layer 712.

The principle is similar to the previous embodiments; here the waveguide 712 is used for the generation of evanescent fields 706 (1-D sub-diffraction limited excitation volume) and in combination with the dielectric 2 that is patterned with nano-holes 4 this results in a 3D sub-diffraction limited excitation volume 4. Advantage of using waveguides 712 compared to samples illuminated with a spot (as in embodiments I) is the higher intensity in waveguides (typical modal area of a waveguide is in the order of a few μm2, which results in intensities in the order of 10-100 kW/cm2 for a 1 mW modal power) and the fact that the mode is propagating so that we can still excite a large area: for a 10 micrometer wide mode, we need a propagation length of 1 mm to excite an area equivalent to 100×100 mm2. The design of lenses 4, 6, blocking filter 5 and detector 7 are similar to the embodiment depicted in FIGS. 4 and 6.

Advantages of the described optical read-out may be the following:
Large multiplexing possibilities for multi-analyte testing: The binding surface 12 in a disposable cartridge can be optically scanned over a large area. Alternatively, large-area imaging is possible allowing a large detection array. Such an array (located on an optical transparent surface) can be made by e.g. ink-jet printing of different binding molecules on the optical surface.

The method also enables high-throughput testing in well-plates by using multiple beams and multiple detectors and multiple actuation magnets (either mechanically moved or electro-magnetically actuated).

The system is really surface sensitive due to the exponentially decreasing evanescent field.

Easy interface: No electrical interconnect between cartridge and reader is necessary. An optical window is the only requirement to probe the cartridge. A contact-less read-out can therefore be performed.

Low-noise read-out is possible.

In the environment of a laboratory, well-plates are typically used that comprise an array of many sample chambers (“wells”) in which different tests can take place in parallel. The production of these (disposable) wells is very simple and cheap as a single injection-molding step is sufficient.

While the invention was described above with reference to particular embodiments, various modifications and extensions are possible, for example:

In addition to molecular assays, also larger moieties can be detected with sensor devices according to the invention, e.g. cells, viruses, or fractions of cells or viruses, tissue extract, etc.

The detection can occur with or without scanning of the sensor element with respect to the sensor surface.

Measurement data can be derived as an end-point measurement, as well as by recording signals kinetically or intermittently.

The particles serving as labels can be detected directly by the sensing method. As well, the particles can be further processed prior to detection. An example of further processing is that materials are added or that the (bio)chemical or physical properties of the label are modified to facilitate detection.

The device and method can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink-jet printing on the optical substrate.

The device and method are suited for sensor multiplexing (i.e. the parallel use of different sensors and sensor surfaces), label multiplexing (i.e. the parallel use of different types of labels) and chamber multiplexing (i.e. the parallel use of different reaction chambers).

The device and method can be used as rapid, robust, and easy to use point-of-care biosensors for small sample volumes. The reaction chamber can be a disposable item to be used with a compact reader, containing the one or more field generating means and one or more detection means. Also, the device, methods and systems of the present invention can be used in automated high-throughput testing. In this case, the reaction chamber is e.g. a well-plate or cuvette, fitting into an automated instrument.

In addition, according to certain aspects, the provision of a dielectric upstanding wall may provide following advantages:

1) For a wire grid sensor having detection volumes having in-plane dimensions smaller than the diffraction limit, similar excitation volumes as in the pinhole biosensor concept are feasible without losing the specific advantages of the wire grid biosensor; higher collection efficiency of the fluorescence because one polarization component of the fluorescence is hardly suppressed, and changing from evanescent to non-evanescent excitation by changing the polarization state of the excitation light.

2) In comparison with a metal pinhole biosensor, the detection volume is surrounded by dielectric materials instead of a metal which may result in a reduction of quenching of fluorescence.

3) The in plane detection volume dimensions can be controlled virtually independent of the in plane aperture dimensions, which define a decay length of the evanescent excitation field.

Other variations to the disclosed embodiments can be understood and effected by those skilled in the art in practicing the claimed invention, from a study of the drawings, the disclosure, and the appended claims. Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. An optical device, for providing evanescent radiation, in response to incident radiation, in a detection volume for containing a target component in a medium, the detection volume having at least one in-plane dimension (W1) smaller than a diffraction limit, the diffraction limit defined by the radiation wavelength and the medium for containing the target components;
wherein the detection volume is provided with at least one wall of a dielectric material.

2. The optical device according to claim 1, wherein the walls of the detection volume are provided with a layer of dielectric material.

3. The optical device according to claim 1, wherein the dielectric material has a refractive index of 1.0 to 1.7.

4. The optical device according to claim 1 wherein the dielectric material is selected from the group comprising poly(tetrafluoroethene), SiO₂, Si₃N₄, SiOₓN_{y} wherein x and y represent the relative fractions, or combinations thereof.

5. The optical device according to claim 1, wherein the detection volume is dimensioned for containing a single target molecule.

6. The optical device according to claim 1, wherein at least one of the in plane detection volume dimensions is smaller than 250 nm.

7. The optical device according to claim 1, comprising aperture defining structures, having a smallest in plane aperture dimension (W1′) smaller than the diffraction limit and surrounding each detection volume.

8. The optical device according to claim 5, wherein said aperture defining structures define a largest in plane aperture dimension W2; wherein said largest in plane aperture dimension is larger than the diffraction limit.

9. The optical device according to claim 5, wherein said aperture defining structures comprise a metal medium provided on the carrier.

10. The optical device according to claim 1, further comprising a sample chamber defined by chamber walls, for containing a medium containing the target components, at least one of the chamber walls of the sample chamber formed by the optical device.

11. The optical device according to claim 1, comprising a top transparent dielectric layer patterned with holes to provide said detection volumes, said transparent dielectric layer defining a layer interface with a lower transparent layer having a refractive index larger than the top dielectric layer, so as to provide evanescent radiation by total internal reflection at the layer interface and in said detection volumes.

12. A microelectronic sensor comprising an optical device according to claim 1, further comprising:
a source for emitting a beam of radiation having a wavelength incident at the optical device; and
a detector for detecting radiation from a target component present in the detection volume of the optical device, in response to the emitted incident radiation from the source.

13. A microelectronic sensor wherein the source is provided as an annular shaped beam, and wherein an optical system is provided to focus the beam towards a detection spot.

14. A method of detecting target components in a medium in one or more detection volumes of an optical device, the detection volume having at least one in-plane dimension (W1) smaller than a diffraction limit, the diffraction limit defined by the radiation wavelength and the medium for containing the target components comprising:
emitting a beam of radiation having a wavelength incident at the optical device;
providing, by the optical device, evanescent radiation, in response to the radiation incident at the optical device, in the detection volume;
detecting radiation from the target component present in the detection volume, in response to the emitted incident radiation; and
bounding said one or more detection volumes by at least one upstanding wall of a dielectric material.

15. A method according to claim 14, wherein a target component concentration in the medium is provided as equivalent to a single molecule in the detection volume.

16. A method according to claim 14, wherein the evanescent radiation is provided by aperture defining structures provided on the binding surface, having a smallest in plane aperture dimension (W1′) smaller than the diffraction limit; and a largest in plane aperture dimension W2 larger than the diffraction limit; and wherein the incident radiation from the source is R-polarized, that is light having an electric field orthogonal to the plane of transmission of the aperture.

17. A method of manufacturing a carrier comprising:
providing, on a substrate, aperture defining structures, having a smallest in plane aperture dimension (W1′) smaller than the diffraction limit; and a largest in plane aperture dimension W2 larger than the diffraction limit and having out of plane dimension D;
filling said aperture defining structures by a dielectric material, to provide a top layer on the aperture defining structures that extends from said structures in an out of plane direction over a distance substantially equal to the out of plane dimension D;
providing slit patterns in the dielectric oriented transverse to the largest in plane aperture dimension; and
etching the top layer back to the out of plane dimension D, so as to provide, in the aperture defining structures upstanding walls of a dielectric material, for providing one or more detection volumes bound to a maximum in plane detection volume dimension (W1) smaller than a diffraction limit, the diffraction limit defined by the radiation wavelength and the medium for containing the target components.

18. A method according to claim 17, wherein said target component is arranged to bind with a biomolecule.
